(19) United States
(12) Patent Application Publication
(10) Pub. No.: US 2021/0367848 A1
(43) Pub. Date: Nov. 25, 2021

(54) A METHOD OF COMMISSIONING A WIRED COMMUNICATION NETWORK

(71) Applicant: SIGNIFY HOLDING B.V., EINDHOVEN (NL)

(72) Inventor: Bjorn Christiaan Wouter KAAG, EINDHOVEN (NL)

(21) Appl. No.: 16/650,244

(22) PCT Filed: Sep. 17, 2018
(86) PCT No.: PCT/EP2018/075025

§ 371 Date: Mar. 24, 2020

(30) Foreign Application Priority Data
Sep. 28, 2017 (EP) 17193629.7

(51) Int. Cl. H04L 12/24; H04L 12/933

(52) U.S. Cl. CPC H04L 41/12; H04L 49/15; H05B 47/18; H04L 41/0869; H04L 41/0823

(57) ABSTRACT

A method of commissioning a wired communication network, wherein said communication network is being configured to comprise a plurality of interconnected Data Forwarding Devices, DFDs in accordance with a network topology plan, wherein said network topology plan identifies how said plurality of DFDs are interconnected, and wherein each DFD has a plurality of ports for connecting to one or more further DFDs, wherein said method comprises the steps of generating link combination codes used to identify cables for interconnections in said network topology plan, wherein each link combination code is based on respective ports to which a respective cable is to be connected, generating unique port combination codes used to identify DFDs in said network topology plan, wherein each port combination code is based on respective ports with which a respective DFD is connected to further DFDs, and wherein said port combination codes are generated such that each DFD in said network topology plan utilizes different sets of ports for said interconnecting and applying said unique port combination codes to said plurality of DFDs.

### FIELD OF THE INVENTION

The present invention generally relates to the field of wired communication networks and, more specifically, to a method for commissioning a wired network. The present invention further relates to a Data Forwarding Device arranged for operating in the wired communication network.

### BACKGROUND OF THE INVENTION

Many commercial, public, or industrial buildings with a plurality of levels and rooms comprise a control system for controlling, for example, the lighting, ventilation, air-conditioning, etc. Devices such as lights or luminaires, light switches, light sensors, thermostats, etc., having a networking capability can be installed as part of a device network that can be centrally and automatically controlled. In a typical building such as a large office complex or a hospital, the device network may comprise many hundreds or even thousands of devices or nodes. Devices may be wireless and can communicate using a suitable wireless protocol. In a wired network such as an Ethernet network, neighbouring devices are physically wired together using a suitable connector such as a twisted pair or a co-axial cable.

The devices are first wired together according to a predefined network topology plan to create such a wired communication network. For example, a certain group of luminaires, for example all the luminaires in one room, can be wired together with a light sensor in a daisy-chain configuration. Each luminaire and sensor can be realised as simple bridges, i.e. with only two ports. One luminaire of the group of luminaires can in turn be wired to a data forwarding device, for example a ‘switch’ or hub, located, for example, in a corridor outside that room. The data forwarding device is, for example, a multi-port bridge. The data forwarding device in turn can be wired to other data forwarding device thereby obtaining the wired communication network. The order in which the devices are to be connected is usually specified in a network topology plan generated using predefined logic, which topology plan can be consulted by an installer responsible for carrying out the wiring. The wired communication network then comprises a plurality of data forwarding devices connected by cables, whereby the data forwarding devices are able to sent and receive messages, i.e. data packets, along the network.

Usually, the luminaires, sensors etc. of the wired communication network are controlled by some suitable control system running on a server, whereby the devices can be individually or collectively controlled by the control system. An example of a prior art dedicated lighting control system operates on a standard such as a digital addressable lighting interface, DALI, for the control of lights. In order to be able to correctly control the devices according to the wishes of the building's occupants or management, the control system must be informed as to which device is located at which physical location in the building. For example, in order to be able to switch on or off the lights in a particular room on a particular level, the control system must know which lights are located in that room. Providing the control system with this type information is encompassed by a ‘commissioning’ process.

It is further known to connect lighting equipment such as sensors, e.g. presence sensors, and actuators, e.g. lights, to a Power Over Ethernet, i.e. PoE, data switch to provide them with power. It is known to manually plan a network topology plan in a graphical way and assign a facility management code to the application components like for example a cable and/or a Data Forwarding Device. One example of an embodiment is a Graphical Information System, i.e. GIS, with a building plan that can generate an overview of components and the rooms they are installed in, either as a table or a graphical building plan.

One of the drawbacks of the known methods of performing commissioning involve much manual input, and are time-consuming, labour-intensive and error-prone. In fact, the commissioning of a prior art lighting control system such as a DALI system can constitute up to one third of the total cost of the system.

International application WO2012/052890 A1 disclose a method that aims to perform automatic commissioning of a network (N) comprising a plurality of network devices, the method comprises the steps of obtaining a computer-readable installation plan for the network, which installation plan comprises a physical location descriptor for each device of the network, deducing the network topology of the network from network descriptive information provided by the devices, and comparing the deduced network topology to the installation plan to allocate a physical location descriptor to a device identifier.

### SUMMARY OF THE INVENTION

It would be advantageous to achieve a method of commissioning a wired communication network which is more reliable and cost-effective. It would also be desirable to achieve a corresponding wired communication network.

To better address one or more of these concerns, in a first aspect of the invention, there is provided a method of commissioning a wired communication network, wherein said communication network is being configured to comprise a plurality of interconnected Data Forwarding Devices, DFDs in accordance with a network topology plan, wherein said network topology plan identifies how said plurality of DFDs are interconnected, and wherein each DFD has a plurality of ports for connecting to one or more further DFDs

The method comprises the step of:
generating link combination codes used to identify cables for interconnections in said network topology plan, wherein each link combination code is based on respective ports to which a respective cable is to be connected;

characterized in that said method comprises the steps of:
generating unique port combination codes used to identify DFDs in said network topology plan, wherein each port combination code is based on respective ports with which a respective DFD is connected to further DFDs, and wherein said port combination codes are generated such that each DFD in said network topology plan utilizes different sets of ports for said interconnecting;
applying said unique port combination codes to said plurality of DFDs.

It was the insight of the inventor that using unique port combination codes to identify the DFDs in the network topology plan in such a way that each port combination code is based on respective ports with which a respective DFD is connected to a further DFD,

and wherein said port combination codes are generated such that each DFD in said network topology plan utilizes different sets of ports for said interconnecting, provides for an advantage.

The advantage hereof is that a DFD is able to configure and/or identify itself, or can be configured, based on the unique port combination code that is applied to the DFD. That is, each port combination code is based on, i.e. derived from, the respective ports with which the DFD is connected to further DFDs. The DFD can thus be identified in the topology plan by connecting cables for interconnections in particular ports of the DFD.

For example, a particular DFD may sense the ports which are used for connection to further DFDs. The port combination code may then be determined, by that particular DFD, based on the sensed ports. This information may be used by the particular DFD to determine its behaviour in the network topology plan. That is, the particular DFD may be able to identify itself in the network topology plan.

The above can be enabled by an installer. The installer, for example, ensures that the cables are inserted in the correct ports. In order to do so, the installer may be provided with the network topology plan which network topology plan may be provided in different formats. The installer ensures that, for each DFD that is being installed, those ports forming a unique port combination are used for connecting that DFD to other DFDs that are indicated in the network topology plan.

A simple example is provided here below to provide a more detailed insight. For example, a network topology plan is created, wherein the network topology plan encompasses ten different DFDs. The DFDs are interconnected to each other in a ring topology. This means that the first DFD is connected to the second DFD, the second DFD is connected to the third DFD, etc., and the tenth DFD is again connected to the first DFD thereby forming the ring topology.

In order to be able to correctly control the devices connected to the DFDs, it is beneficial that each particular DFDs is correlated to a particular DFD in the network topology plan. As such, a DFD installed at a particular location should be informed that that DFD corresponds to the DFD in the network topology plan at that particular location. This should be applied for all DFD's that are installed. Such aspects are covered by a commissioning process.

Link combination codes and unique port combination codes are then generated in accordance with the present disclosure. For example, a first port combination code of [1,2] is generated for the first DFD, which indicates that the first DFD is connected to the tenth DFD using port 1 and connected to the second DFD using port 2. A second port combination code of [1,3] is then generated for the second DFD, which indicates that the second DFD is connected to the first DFD using port 1 and connected to the third DFD using port 3, etc.

The port combination code is then a unique reference to a particular DFD on specified locations in the network topology plan. An installer will then start installing, i.e. placing, the DFDs in a building in accordance with the topology plan once all the link combination codes and port combination codes are generated for the cables and the DFDs in the network topology plan.

It is noted that the present disclosure is mainly focused on port combination codes that are construed based on two occupied ports of a particular DFD. It is however noted that it may also be possible to use three, four or even more ports on a particular DFD to connected that particular DFD to other DFDs in the network. In such a case, the port combination code may be based on all three, four or even more ports used for that purpose.

As such, the installer may start by installing a first DFD in the network topology plan. One of the advantages of the above is that the DFDs, i.e. the hardware components, do not need to be equipped with particular codes prior to installation and the installer, therefore, has complete freedom to install any DFD, i.e. any hardware component, from a stack of identical DFDs right out of the box.

As such, the installer picks a random DFD and intends to place that particular DFD as the first DFD on the specified location in the building as informed in the network topology plan or any other suitable form of information. As explained above, the port combination code corresponding to the first DFD is [1,2]. The installer may be aware of the port combination codes for all DFDs in the network topology plan. As such, the installer ensures that the first port “1” is used in the first DFD for connecting that DFD to the tenth DFD and that the second port “2” is used in the DFD for connecting that DFD to the second DFD.

This process then continues for each of the DFDs in the network topology plan, wherein the installers ensures that each of the DFDs are connected to other DFDs in the ring topology by using their corresponding ports, which corresponding ports are indicated by the unique port combination codes.

Each of the DFDs are then configured, for example in a commissioning procedure. That is, each of the DFDs are coupled to, i.e. identified with, a particular DFD in the network topology plan. This is accomplished by the step of applying the unique port combination codes to the plurality of DFDs. A particular DFD may, for example, sense the ports that are used for connecting that particular DFD to further DFDs and that information may be used to configure that particular DFD. Such a configuration may be performed in different ways, two of which are explained here below in more detail.

First, the network topology plan, comprising at least the unique port combination codes, may be provided to each of the DFDs in the network topology plan. This can be accomplished by pre-configuring all of the DFDs before they are installed, or can be accomplished once the DFDs are (fully) connected to each other. The particular DFD is able to correlate itself with a DFD in the network topology plan based on the sensed ports. For example, the particular DFD senses that is uses ports “1” and “2” for connecting to further DFDs. This indicates to that particular DFD that it is applied the port combination code [1,2], which was assigned to the first DFD in the network topology plan. That particular DFD will then configure itself as if it is the first DFD of the network topology plan. The same process is performed for each of the DFDs in the network until that the commissioning process is completed.

Second, each DFD may determine its applied port combination code by sensing the ports used for the interconnection as explained above. The DFDs may then, subsequently, request for their configuration from a control server using their determined port combination code. The DFDs then configure themselves based on instruction messages received from the control server and/or load additional settings and/or software.

The Data Forwarding Device may, in accordance with the present disclosure, be a switch, a router, a bridge, a gateway or a hub, with or without a wireless transceiver. Such devices are, for example, networking devices that connect other endpoint devices in the network together. Such endpoint devices are, for example, lights or luminaires, light switches, light sensors, thermostats, etc. The networking devices are also connected to each other, i.e. interconnected with each other, to form a wired communication network. Each networking device has a plurality of ports, which ports can be used for connection to a further networking device or to an endpoint device. Typically, the networking devices have 8, 16, 32, 50 or 100 ports available to do so.

In an embodiment, the port combination codes are generated such that each DFD in said network topology plan utilizes different sets of ports for said interconnecting, wherein said sets of ports preferably exclude mirrored ports.

The inventor has had the insight that a potential risk may occur in case mirrored port combination codes are used for the different DFDs in the wired communication network. For example, a first DFD in the wired communication network may be associated with the port combination code [1,2] and a sixth DFD in the wired communication network may be associated with the port combination code [2,1]. These two codes are an example of mirrored port combination codes. The advantage of not using mirrored port combination codes in the generating process is that the risk of confusion is reduced. As such, the method according to the present embodiment avoids the generating of mirrored combination codes to increase the robustness of the wired communication network, and thus also of the installation process of the wired communication network.

It is noted that in a “small risk” mode, mirrored port combination codes may be used in parts of the network not adjacent to each other; by carefully planning port combination codes there is a reduced risk of missing detection of an installation error.

It is also noted that the system may identify and propose an ideal port combo code to start the installation with, so as to speed up the correct detection of a cable segments and DfDs. For this purpose the system may propose unique codes with more than two ports to maximize changes of recognition early in the process.

In a further embodiment, the step of applying said unique port combination codes comprises the steps of:
receiving, by a particular DFD identified by a corresponding particular port combination code, a cable in two of said respective ports;
determining, by said particular DFD, said corresponding particular port combination code by recognizing said respective ports to which said cable is connected.

In this example, the DFD may be able to put itself in a learning mode. The installer connects a cross cable to the ports as stipulated by the port combination code and the DFD is, in the learning mode, able to identify the code. One end of the cross cable is connected in a first port of the port combination code and a second end of the cross cable is connected in a second port of the port combination code. The DFD is then able to determine the particular port combination code by determining that those two ports of the port combination code are directly connected to each other. The thus assigned port combination code may be stored by the DFD such that the DFD is able to identify itself in the wired communication network.

In a further embodiment, the said step of applying said unique port combination codes comprises the steps of:
transmitting, by a particular DFD identified by a corresponding particular port combination code, a message comprising a device identification identifying said particular DFD and a port identification identifying said port over which said message is transmitted;
receiving, by a control system, said transmitted message, and mapping said device identification with said corresponding port combination code.

In this particular scenario, the DFD may be able to notify its device identification and port numbers. A separate, preferably handheld, portcombo tool with display or status signals may then be interconnected using cables between the corresponding ports of the port combination code. The portcombo tool is effectively a portable computing device that may be provided to installers and that has ports; i.e. cable terminals for connecting cables there to. The portcombo tool may then send messages to the DFD requesting the DFD to send those messages to the control system, wherein those messages comprise the device identification and the port(s) over which the messages was sent. The DFD may also autonomously send those messages without being requested to do so by the portcombo tool. The control system is then able to determine the applied port combination code by investigating the port(s) comprised by the messages.

The advantage hereof is that many legacy DFDs already have the capability to notify their identification and the ports over which a message is being transmitted. The effect hereof is thus that legacy DFDs can be used in the installation process.

In a further embodiment, the method further comprises the steps of:
verifying whether said applied unique port combination codes to said plurality of DFDs correspond to said generated unique port combination codes for said plurality of DFDs.

The above identified step of the method may, for example, be performed by a control server or by a separate, preferably handheld, portcombo tool. A validation process may be initiated once one or more unique port combination codes have been applied to one or more DFDs. The validation process may entail that each of the one or more DFDs express, or reveal, their applied port combination code to the control server and/or to the portcombo tool. The portcombo tool and/or the control server may use this information to reconstruct the network topology plan. Wrongly applied port combination codes may then be recognized by comparing the (intended) network topology plan with the reconstructed network topology plan.

The advantage of this embodiment is that an installer is able to immediately check whether a connected DFD is connected in the correct way. That is whether the DFD is connected in line with the network topology plan.

In a more detailed embodiment hereof, the step of verifying comprises:
transmitting, by a particular DFD or a portcombotool, a verification message comprising its corresponding applied unique port combination code;
receiving, by a control system, said transmitted verification message, and
verifying, by said control system, whether said applied unique port combination code corresponds to said generated port combination code.

In a further embodiment, the step of verifying indicates that said applied unique port combination code does not correspond to said generated port combination code, said method further comprises the step of:
determining, by said control system, which cable is misplaced in ports of said particular DFD based on said applied unique port combination code and said generated port combination code, and
providing, by said control system, guidance to an installer by indicating how to replace said cable in said ports of said particular DFD.

The advantage of the embodiment as described above is that the installer is guided to the solution. That is, the installer is helped in how to resolve the issue that the particular DFD is provided with the incorrect port combination code. The installer may, for example, be directed to the fact that one of the cable is misplaced and that that particular cable should be reconnected to a different port.

As such, the installer instantly receives feedback about the validity of the installation process and is thus able to act immediately in case an error is detected.

In a second aspect of the present disclosure, there is provided a wired communication network being configured to comprise a plurality of interconnected Data Forwarding Devices, DFDs in accordance with a network topology plan, wherein said network topology plan identifies how said plurality of DFDs are interconnected, and wherein each DFD has a plurality of ports for connecting to one or more further DFD's, wherein:
link combination codes are generated, which link combination codes are used to identify cables for interconnections in said network topology plan, wherein each link combination code is based on respective ports on the respective DfDs to which a respective cable is to be connected, and
unique port combination codes are generated, which unique port combination codes are used to identify DFDs in said network topology plan, wherein each port combination code is based on respective ports with which a respective DFD is connected to further DFDs, and wherein said port combination codes are generated such that each DFD in said network topology plan utilizes different sets of ports for said interconnecting;

Here, each DFD is arranged to apply its corresponding generated unique port combination codes.

It is noted that the advantages and definitions as disclosed with respect to the embodiments of the first aspect of the disclosure, being the method of commissioning a wired communication network, also correspond to the embodiments of the second aspect of the present disclosure, being the wired communication network, respectively.

In other words, there is provided a wired communication network which comprises a plurality of interconnected Data Forwarding Devices, DFDs, wherein each DFD has a plurality of ports for connecting to one or more further DFD's, wherein each DFD in the wired communication network utilizes different, unique, sets of ports for interconnection with said one or more further DFD's. Preferably, unique link combination codes are used to identify cables for interconnections in the network topology plan, wherein each link combination code is based on respective ports to which a respective cable is to be connected.

The wired communication network may, for example, comprise at least 20, more preferably at least 50, even more preferably at least 100 DFD's.

In an embodiment, said port combination codes are generated such that each DFD in said network topology plan utilized different sets of ports for said interconnecting, wherein said sets of ports exclude mirrored ports.

The number of DFDs may be determined by the number of unique port combination codes which is linked to the number of ports on a DFD. When avoiding using mirrored port combination codes, any 16 port DFD can support 120 different port combination codes using 2 interlink cables and 1920 unique codes using 3 interlink cables to other DFDs. As stated before, mirrored codes may be used by careful planning the codes not to be adjacent in the network. With mirrored port combination codes a 16 port DFD can support 240 unique codes using 2 interlink cables and 3840 unique codes using 3 interlink cables. Even larger control networks may be accommodated for by defining multiple segments, wherein each segment uses a unique prefix in combination with the generated port combo codes.

It is noted that the method for installing a communication network as disclosed above involves the installation of cables to connect to sensors and/or actuators or anything alike. That is, the DFDs should be connected to each other in accordance with the network topology plan, and the different sensors and/or actuators need to be connected to the respective DFDs. During the installation of the cables, it may happen that walls are to be crossed to interconnect the sensors, actuators and the different DFDs. When multiple cables are to be installed, those cables may be fed through holes in the walls.

It may be difficult to pick up a correct cable from the bunch of cables as they all look the same. That problem is aggravated when fire safety regulations require the cable holes in the walls to be closed. It is clear that in the latter case, a cable is completely fixed in position and cannot be moved by a person on one side of the wall for identification by a second person on the opposing side of the wall. Prior art is available in which the cables are labelled or an RFID tag is attached to the cables. This is, however, cumbersome and therefore not desired.

In a next aspect, the present disclosure proposes a method to identify a correct cable from a bunch of visually similar cables, and to detect that the cable was installed correctly on the other side of the wall. The proposed method uses the concept of the present disclosure, i.e. the wired communication network, wherein unique port combination codes are used as well as unique link combination codes.

As such, a method is proposed for identifying a cable in a communication system in accordance with any of the examples provided above, wherein said method comprises the steps of:
generating, by a particular DFD a commission node or a selection tool, a link combination code for one of the cables connected to that particular DFD;
transmitting said generated link combination code over said one cable, and
identifying said cable, by a selection tool connected at an other end of said one cable, a selection tool here is a portable computing device that has at least one port; i.e. a terminal for connecting a cable, that allows it to receive messages over the cable, the selection tool thus enables the selection of the right cable.

The mechanism is to put the generated link combination code on the cable on one end first, i.e. the end at the DFD, and detect its presence or absence on the other side.

The link combination code may be generated as a digital message or as a distinct pattern of voltage and/or current variations. The link combination code can be generated by a DFD in accordance with the present disclosure, a commissioning node, or alternatively by a selection tool after connecting a first side of the cable. The selection tool is connected to the other side of the cable and detects if the link combination code is present or absent.

The tool gives due feedback about the cable selected being the correct one or not. If the cable under test is not the correct one the process may be repeated with subsequent cables until the correct cable is found.

The aspect described above may be deployed in several situations. For example:

Situation 1 utilizing an operational DFD.

A preferred example uses a DFD in a system in accordance with the present disclosure. As an additional step of the present disclosure is that the DFD is able to generate the link combination code when one cable end is inserted into a data port on the DFD. The link combination code is, for example, contained in the application control plan and is, for example, provided as information to the DFD by means of a port combo tool and/or a software defined application system.

Situation 2 utilizing a commissioning node.

An alternative example uses a commissioning node, i.e. an embedded device with a port, i.e. a cable terminal, that is emulating a DFD. The commissioning node may not implement all options from the selection tool. A user interface may minimally offer the possibility to select an link combination code from the plan, for example by referring to the code for the space, the code for the DFD or the code for the link combination code. The device will provide feedback about the selected setting and if the digital message, or voltage or current pattern, is generated. Naturally the message is generated when the opposite connects and has passed the requirements to set up the physical and logical channel on the cable.

Situation 3 utilizing refers to a selection tool.

Upon connection of the cable to a port, i.e. a cable terminal, on the selection tool, said tool detects the presence of the link combination code on the cable and compares the detected link combination code with the code that was expected from the application control plan

In a further embodiment, a DFD comprises:
receive equipment arranged for receiving a cable in two of said respective ports;
process equipment arranged for determining said corresponding particular port combination code by recognizing said respective ports to which said cable is connected.

In a third aspect of the present disclosure, there is provided a Data Forwarding Device arranged to be operative in a wired communication network in accordance with any of the examples of the wired communication network as provided above.

In a fourth aspect of the present disclosure, there is provided a network, comprising:
a wired communication network in accordance with any of the examples as provided above, and
a control system comprising a control server, wherein said control server comprises:
   receive equipment arranged for receiving, from a particular DFD, a verification message comprising a corresponding applied unique port combination code for said particular DFD, and
   verify equipment arranged for verifying whether said applied unique port combination code for said particular DFD corresponds to said generated port combination code.

In an embodiment hereof, the receive equipment is further arranged for receiving a message transmitted by a particular DFD, wherein said message comprises a device identification identifying said particular DFD and a port identification identifying said port over which said message is transmitted by said particular DFD,

and wherein said control server further comprises:
map equipment arranged for mapping said device identification with a corresponding port combination code.

In a fifth aspect of the present disclosure, there is provided a computer program product, comprising a readable storage medium, comprising instructions which, when executed on at least one processor, cause the at least one processor to carry out the method according to any of the examples as provided above.

These and other aspects of the invention will be apparent from and elucidated with reference to the embodiment(s) described hereafter.

### BRIEF DESCRIPTION OF DRAWINGS

FIG. 1 shows an example of a domain model to elucidate the presented method.

FIG. 2 shows an example of the basic steps in accordance with an example of the present disclosure.

FIG. 3 discloses an example of a network design which is used for elucidating the presented method.

FIG. 4 discloses an example of a port combination code table.

FIG. 5 discloses an example of a link combination code table.

FIG. 6 discloses an example of a Data Forwarding Device.

FIG. 7 discloses an example of a method in accordance with the present disclosure.

### DETAILED DESCRIPTION

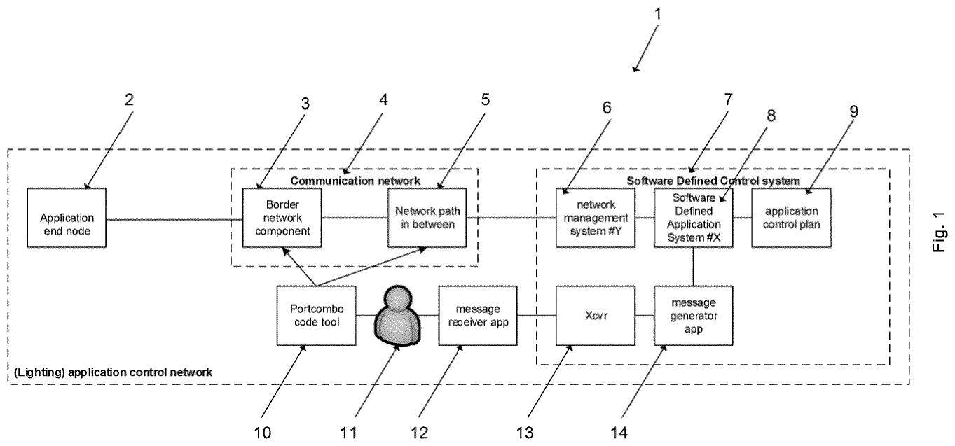

FIG. 1 shows an example of a domain model 1 to elucidate the presented method.

The domain model 1 shown in FIG. 1 is included to provide background information with respect to the present disclosure. Here, a Control System 7 is provided which comprises a Software Defined Application system 8. The Software Defined Application system 8 is arranged to generate an application control plan with a network topology plan 9 with unique combination codes for use within the present disclosure. The message generator app 14 is arranged to produce context based information, transmit the information using a Transceiver 13 for reception by a message receiver app 12 of an intended installer 11. The Installer 11 can read the information and use a portcombo tool 10 to apply the unique port combination codes to the respective Data Forwarding Devices, DFDs, at a specific location in a network, which may be a path in between 5 and/or a border network component 3 of the communication network 4.

The components as referenced to with reference numerals 3 and 6 are interconnected using interlinks via a network path in between 5. Application end node 2 is connected via a borderlink to the border network component 3. The Software Defined Application system 8 is arranged to dynamically detect the network paths making up the communication network 4, be them the interlinks and the borderlinks by using e.g. a network management system 6. The Software Defined Application system 7 is arranged to consult the network topology plan from the application control plan 9 and the previously designed network topology and requirements stipulated therein, so as to perform an analysis between the planned network topology and the actually installed network topology. The progression may be dynamically followed and appropriate status and error messages may be sent to the installer 11.

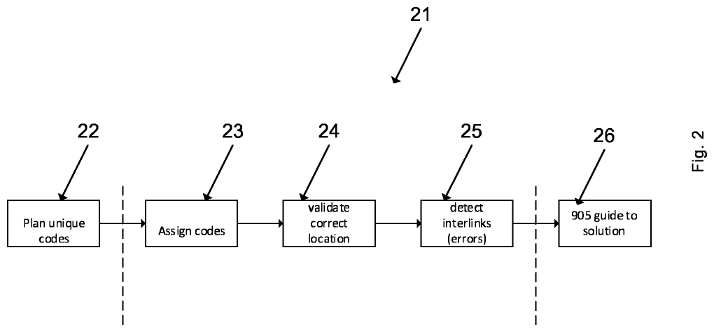

FIG. 2 shows an example of the basic steps 21 in accordance with an example of the present disclosure.

In a first step, link combination codes and port combination codes are generated 22. The link combination codes are used to identify cables for interconnections in the network topology plan, wherein each link combination code is based on respective ports to which a respective cable is to be connected. The unique port combination codes are used to identify DFDs in the network topology plane, wherein each port combination code is based on respective ports with which a respective DFD is connected to further DFDs, and wherein the port combination codes are generated such that each DFD in the network topology plan utilizes different sets of ports for the interconnecting.

The above described unique port combination codes may aid an installer in the installation process, and may aid the installer in verifying whether the DFDs have been connected correctly.

The generated port combination codes are then assigned 23, i.e. applied, to the respective DFDs. As mentioned before, such an assignment process may take different forms. In one of the examples, the installer may connect a cross cable between the ports of an DFD that are used for connecting that particular DFD to further DFDs. The particular DFD may sense the ports that are used for the cross cable connection to identify which DFD it is in the network topology plan.

Next, a validation process 24 may be initiated. The validation process may be started upon installing all DFDs in the network topology plan, or may be run in parallel. That is, the validation process may continuously check whether a freshly installed DFD is installed correctly. It may thus be validated that a particular DFD is installed correctly on a pre-planned location by comparing the applied code with the pre-planned generated port combination code for that particular DFD.

As such, a error detection process 25 may be initiated. The progress of the installation of the network, i.e. the DFDs in the network, may be followed and it may be validated whether the progress in in line with the network topology plan. It may be detected if the installed topology of then network deviates from the network topology plan.

Finally, a guidance process 26 may be initiated. The installer may be guided in such a way that the installer is able to correct any erroneously connected DFDs.

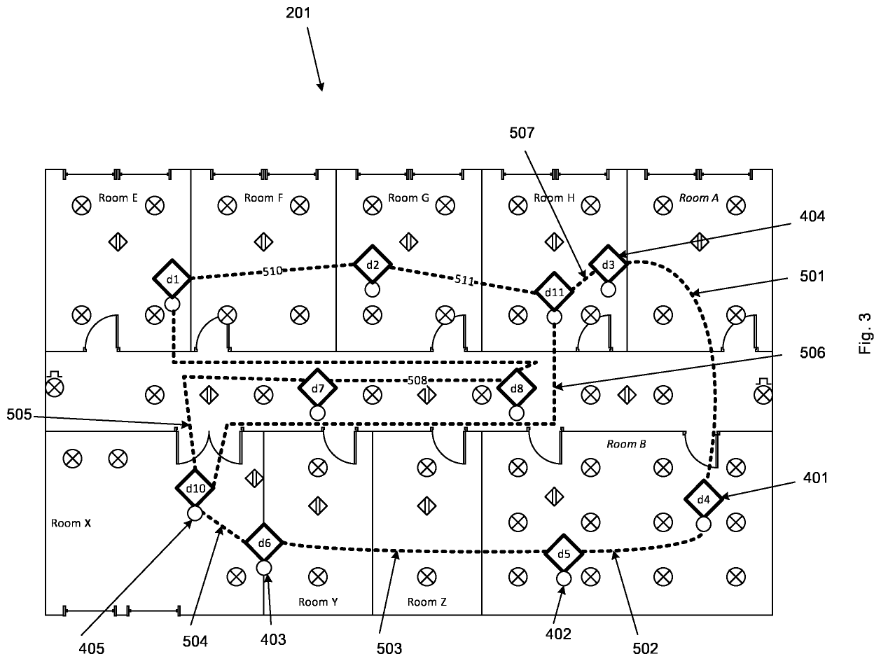

FIG. 3 discloses an example of a network design 201 which is used for elucidating the presented method.

Shown is a building having a plurality of rooms, i.e. rooms A, H, G, F, E, X, Y, Z, B. The corresponding network topology plan indicated that a plurality of DFDs are to be installed in the building. The DFDs are referenced to with the reference numerals d1, d2, d3, d4, d5, d6, d7, d8, d10 and d11.

The DFDs are connected to each other, for example in some sort of ring topology, using the interlinks as indicated with the bold dashed lines. For example the DFD d1 is connected to the DFD d2 as well as to the DFD d8. Each of the DFDs may further be connected to sensors, actuators, lights, etc.

According to the presented method there is provided a wired communication network which comprises a plurality of interconnected Data Forwarding Devices, DFDs, wherein each DFD has a plurality of ports for connecting to one or more further DFD's, wherein each DFD in the wired communication network utilizes different, unique, sets of ports for interconnection with said one or more further DFD's.

For example, a port combination code 401 is assigned to code 8(501)+4(502), which entails that the cable 501 should be inserted in port 8 of DFD 401 and cable 502 should be inserted on port 4 of DFD 401. An example of a link combination code 501 is d3p1+d4p8, which entails that this cable should interconnect DFD d3 via its port 1 and DFD d4 via its port 8. Correspondingly, a port combination code 402 is assigned as 3(502)+6(503), etc.

During the installation process of the DFDs, several states may be recognized.

A validation correct state. As an example port combination code 401 was generated to interconnect DFD d4 to DFD d5 via cable 502 on port 4 and to DFD d3 via cable 501 on port 8. Since both cables are connected to other operating DFDs d3 and d5 the interlink is up and running. The status of the DFD in the network plan is updated accordingly, the DFD may update its local feedback and/or the installer is informed appropriately.

A validation pending state. At any moment during the installation some interlink cables could have been connected to one DFD but not yet to the second DFD. In that state the fully interconnected cable may be shown and the other cable identified as pending. When an installation error has been made and a particular cable was forgotten or damaged during installation, it can be shown where to begin the search for this kind of error.

A validation error state. As an example port combination code 402 was generated to interconnect DFD d5 to DFD d6 via cable 503 on port 6 and to DFD 4 via cable 502 on port 3. It could be that, in practice, cable 503 was inserted in port 5 of DFD d5 and that is considered a mistake or an error. The system can notify said error directly to the installer with guidance to its proper solution; for example by indicating that the installer should revisit DFD d5 and re-plug the interlink cable 503 from port 5 to port 6. The status of the DFD in the network plan may then be updated accordingly, the DFD may update its local feedback and/or the installer may be informed appropriately.

Once the system has detected one or more DFDs and one or more interlinks, due feedback may be given to the installer. Several messages may be generated and communicated.

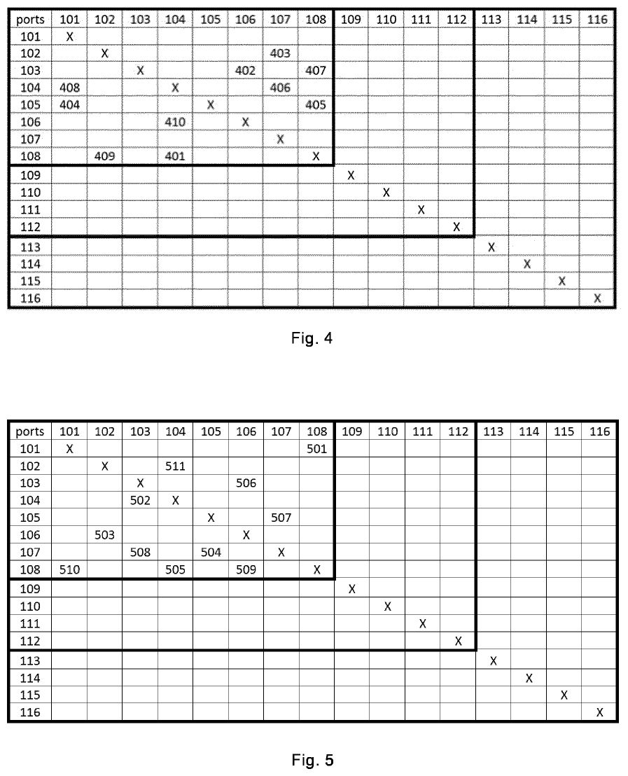

FIG. 4 discloses an example of a port combination code table, and FIG. 5 discloses an example of a link combination code table.

Here, it is noted that the example uses an eight port DFD, but the invention can accommodate for DFDs with more ports such as for example but not limited to 12 and 16 port DFDs.

Consider the port combination code table shown in FIG. 4. Here, the network topology plan is directed to a concept in which DFDs are used having eight ports. Further, in this particular example, each DFD uses two ports for connection to further DFDs. The remaining ports may be used for connection to sensors, actuators and/or lights. The table contains numbers in the 400 range. These numbers constitute the port combination codes. For example, reference number 403 is directly related to a particular DFD in the network topology plan. As such, that particular DFD is identified by the port combination code 403. The port combination code 403 indicates that the ports 102 and 107 should be used for that particular DFD to connected that particular DFD to two further DFDs. The table shown in FIG. 4 does not disclose to which further DFDs the particular DFD should be connected. As shown, the port combination codes are unique meaning that each cell of the table is only used once. Each cell of the table may identify a single DFD in the network topology plan.

A similar explanation may be provided for the table shown in FIG. 5. Here, the table contains numbers in the 500 range. These numbers constitute the link combination codes. For example, reference number 5 is directly related to a specific cable for interconnecting two DFDs with each other. As such, that particular cable is identified by the link combination code 501. The link combination code 501 indicates that the ports 101 and 108 should be used for that particular cable. The table shown in FIG. 5 does not disclose to which DFDs the cable should be connected. As shown, the link combination codes are unique meaning that each cell of the table is only used once. Each cell of the table may identify a single DFD in the network topology plan.

An installer may start with the installing of the DFDs in the building once these tables have been generated. The installer should apply the port combination codes to each of the DFDs that are being installed in the building. The installer may use the port combination code in any format provided and start up the DFD. The port combo code may be applied to the DFD in many different ways.

In a first example, the concept is build into the DFD itself. In an embodiment, the DFD is put in a special learning mode. The installer may then connect a cross cable to the exact ports as stipulated by the port combination code and the DFD may learn the code. The port combination code may be memorized so it can be transmitted on the cable as a signalling message in a later stage. Once the DFD has given feedback that due procedure has been followed, the cross cable may be removed and the proper interlink cables may be connected to the ports as indicated in the network topology plan.

In a second example, the concept uses a portcombo tool. Here, the DFD may be capable to notify its device and port Identifications, IDs. An alternative example is using an DFD with the capability to notify its DFD ID and its port IDs such as, for example, an OpenFlow Ethernet switch.

A separate, preferably handheld portcombo tool may be provided and may be interconnected by short path cables between the corresponding ports on the DFD as indicated by the to be applied port combination code. The application is completed by the portcombo tool sending appropriate messages to the DFD for it to send appropriate messages down the cables for recording by the Software Defined Application system. The application system may observe the signal and map that to the ID of the respective DFD where the message came from. Due feedback is generated for either match or mismatch.

In a further example, the concept uses a portcombo tool using a DFD not able to notify its device and port IDs. Another alternative example will use a DFD without the invention installed and without the capability to notify a DFD ID and port ID. A separate, preferably handheld portcombo tool with display or status signals will be interconnected by short path cables between the corresponding ports of the port combination code. The application is completed by the portcombo tool sending appropriate messages down the cables for recording by Software Defined Application system. The installer may need to confirm that the cables are installed in the correct ports, for example by making a photo with a camera build into the tool and/or confirming a question shown on the display of the portcombo tool. The port combo tool may record this action for alternative, e.g. wireless transmission via the message receiver to the application system. The application system may observe the signal, perform image recognition of the photograph and map that to the ID of the DFD where the message came from. Due feedback may be generated for either match or mismatch.

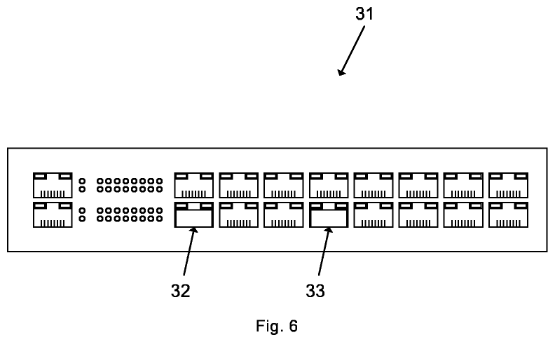

FIG. 6 discloses an example of a Data Forwarding Device, DFD, 31.

The DFD 31 may comprise a plurality of ports which can be used for connecting that particular DFD 31 to further DFDs or to sensors, actuators and/or lights. In this particular situation two ports are used for connecting that particular DFD 31 to further DFDs. These ports are indicated with reference numerals 32 and 33. As such, the port combination code for this particular DFD 31 is deduced from the identifications of the ports with reference numerals 32 and 33.

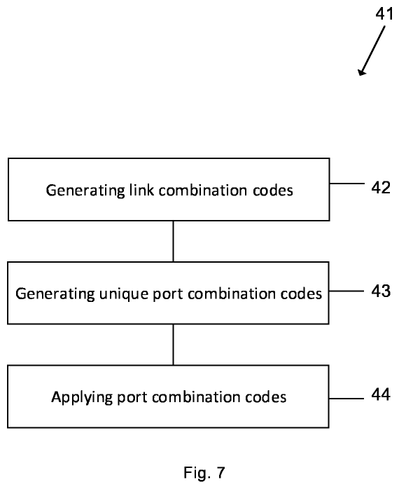

FIG. 7 discloses an example of a method in accordance with the present disclosure.

Here, method 41 of commissioning a wired communication network is disclosed, wherein said communication network is being configured to comprise a plurality of interconnected Data Forwarding Devices, DFDs in accordance with a network topology plan, wherein said network topology plan identifies how said plurality of DFDs are interconnected, and wherein each DFD has a plurality of ports for connecting to one or more further DFDs.

The method comprises the steps of:
generating link combination codes 42 used to identify cables for interconnections in said network topology plan, wherein each link combination code is based on respective ports to which a respective cable is to be connected;

characterized in that said method comprises the steps of:
generating unique port combination codes 43 used to identify DFDs in said network topology plan, wherein each port combination code is based on respective ports with which a respective DFD is connected to further DFDs, and wherein said port combination codes are generated such that each DFD in said network topology plan utilizes different sets of ports for said interconnecting;
applying said unique port combination codes 44 to said plurality of DFDs.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope thereof.

The algorithms may run on a software defined control system, in the DFD, in the port combo tool or as a virtualized process on any compute unit in communicado with the application control network, either in real time or in store and forward operation mode.

1. A method of commissioning a wired communication network, wherein said communication network is being configured to comprise a plurality of interconnected Data Forwarding Devices, DFDs in accordance with a network topology plan, wherein said network topology plan identifies how said plurality of DFDs are interconnected, and wherein each DFD has a plurality of ports for connecting to one or more further DFDs, wherein said method comprises the steps of:
generating link combination codes used to identify cables for interconnections of DFDs in said network topology plan, wherein each link combination code indicates two DFDs that an interconnecting cable is to be connected to and the respective DFD ports on these DFDs that the interconnecting cable is to be connected to;
characterized in that said method comprises the steps of:
generating unique port combination codes used to identify DFDs in said network topology plan, wherein each port combination code is based on respective ports with which a respective DFD is connected using a cable to further DFDs, and wherein said port combination codes are generated such that each DFD in said network topology plan utilizes different sets of ports for said interconnecting and wherein said sets of ports exclude mirrored ports;
applying said unique port combination codes to said plurality of DFDs such that each DFD is interconnected in accordance with a different one of the generated unique port combination codes; and
verifying whether said applied unique port combination codes to said plurality of DFDs correspond to said generated unique port combination codes for said plurality of DFDs.

2. (canceled)

3. A method of commissioning a wired communication network in accordance with claim 1, wherein said step of applying said unique port combination codes comprises the steps of:
receiving, by a particular DFD identified by a corresponding particular port combination code, a cable in two of said respective ports;
determining, by said particular DFD, said corresponding particular port combination code by recognizing said respective ports to which said cable is connected.

4. A method of commissioning a wired communication network in accordance with claim 1, wherein said step of applying said unique port combination codes comprises the steps of:
transmitting, by a particular DFD identified by a corresponding particular port combination code, a message comprising a device identification identifying said particular DFD and a port identification identifying said port over which said message is transmitted;
receiving, by a control system, said transmitted message, and mapping said device identification with said corresponding port combination code.

5. (canceled)

6. A method of commissioning a wired communication network in accordance with, wherein said step of verifying comprises:
transmitting, by a particular DFD, a verification message comprising its corresponding applied unique port combination code;
receiving, by a control system, said transmitted verification message, and
verifying, by said control system, whether said applied unique port combination code corresponds to said generated port combination code.

7. A method of commissioning a wired communication network in accordance with claim 6, wherein said step of verifying indicates that said applied unique port combination code does not correspond to said generated port combination code, said method further comprises the step of:
determining, by said control system, which cable is misplaced in ports of said particular DFD based on said applied unique port combination code and said generated port combination code, and
providing, by said control system, guidance to an installer by indicating how to replace said cable in said ports of said particular DFD.

8. A network comprising:
a wired communication network being configured to comprise a plurality of interconnected Data Forwarding Devices, DFDs in accordance with a network topology plan, wherein said network topology plan identifies how said plurality of DFDs are interconnected, and wherein each DFD has a plurality of ports for connecting to one or more further DFD's, wherein:
link combination codes are generated, which link combination codes are used to identify cables for interconnections of DFDs in said network topology plan, wherein each link combination code is based on respective ports to which a respective cable is to be connected, and
unique port combination codes are generated, which unique port combination codes are used to identify DFDs in said network topology plan, wherein each port combination code is based on respective ports with which a respective DFD is connected using a cable to further DFDs, and wherein said port combination codes are generated such that each DFD in said network topology plan utilizes different sets of ports for said interconnecting and wherein said sets of ports exclude mirrored ports;
wherein each DFD is interconnected in accordance with a different one of the generated unique port combination codes and
a control system comprising a control server, wherein said control server comprises:
receive equipment arranged for receiving, from a particular DFD, a verification message comprising a corresponding applied unique port combination code for said particular DFD, and
verify equipment arranged for verifying whether said applied unique port combination code for said particular DFD corresponds to said generated port combination code.

9. (canceled)

10. A network in accordance with claim 6, wherein a DFD comprises:
receive equipment arranged for receiving a cable in two of said respective ports;
process equipment arranged for determining said corresponding particular port combination code by recognizing said respective ports to which said cable is connected.

11. (canceled)

12. (canceled)

13. A network in accordance with claim 6, wherein:
said receive equipment is further arranged for receiving a message transmitted a particular DFD, wherein said message comprises a device identification identifying said particular DFD and a port identification identifying said port over which said message is transmitted by said particular DFD,
and wherein said control server further comprises:
map equipment arranged for mapping said device identification with a corresponding port combination code.

14. (canceled)
